(19) United States
(12) Patent Application Publication
(10) Pub. No.: US 2024/0396077 A1
(43) Pub. Date: Nov. 28, 2024

(54) LOW-COST AND LOW-DENSITY SOLID ELECTROLYTE COMPOSITE FOR SOLID-STATE BATTERY

(71) Applicant: GM GLOBAL TECHNOLOGY OPERATIONS LLC, Detroit, MI (US)

(72) Inventors: Zhe LI, Shanghai (CN); Qili SU, Shanghai (CN); Yong LU, Shanghai (CN); Dave G. RICH, Sterling Heights, MI (US); Haijing LIU, Shanghai (CN)

(21) Appl. No.: 18/365,365

(22) Filed: Aug. 4, 2023

(30) Foreign Application Priority Data
May 22, 2023 (CN) 202310582378.6

(51) Int. Cl. H01M 10/056

(52) U.S. Cl. CPC H01M 10/056; H01M 2300/0071; H01M 2300/0082

(57) ABSTRACT

A solid-state battery cell includes an anode electrode comprising an anode current collector, anode active material, a solid electrolyte, and a gel polymer electrolyte. A cathode electrode comprises a cathode current collector, a cathode active material, a solid electrolyte, and the gel polymer electrolyte. A separator layer comprises the gel polymer electrolyte and a solid electrolyte composite including a solid electrolyte coating arranged on an outer surface of an oxide core.

### CROSS-REFERENCE TO RELATED APPLICATIONS

This application claims the benefit of Chinese Patent Application No. 202310582378.6, filed on May 22, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to solid-state batteries, and more particularly to batteries including a solid electrolyte composite.

Electric vehicles such as battery electric vehicles and hybrid vehicles are powered by a battery pack including one or more battery modules each having one or more battery cells. The battery cells include anode electrodes, cathode electrodes, and separator layers. The anode electrodes typically include anode active layers arranged on an anode current collector. The cathode electrodes typically include cathode active layers arranged on a cathode current collector.

Solid-state batteries (SSB) have the potential to be superior to state-of-the-art lithium-ion batteries in terms of abuse tolerance, working temperature range, and power capability. As a key component in SSB cell architecture, lithium-ion-conducting solid electrolytes have attracted great interest. However, the high cost of solid electrolyte hinders large-scale application of SSBs. The solid electrolyte has a high density (e.g., 2 g/cm³ to 5 g/cm³), which decreases the gravimetric energy density of battery.

### SUMMARY

A solid-state battery cell includes an anode electrode comprising an anode current collector, anode active material, a solid electrolyte, and a gel polymer electrolyte. A cathode electrode comprises a cathode current collector, a cathode active material, a solid electrolyte, and the gel polymer electrolyte. A separator layer comprises the gel polymer electrolyte and a solid electrolyte composite including a solid electrolyte coating arranged on an outer surface of an oxide core.

In other features, the solid electrolyte in the anode electrode includes the solid electrolyte composite. The solid electrolyte in the cathode electrode includes the solid electrolyte composite. The solid electrolyte in the anode electrode and the cathode electrode includes the solid electrolyte composite. The anode active material is selected from a group consisting of carbonaceous material, silicon, silicon mixed with graphite, Li₄Ti₅O₁₂, a transition-metal, a metal oxide/sulfide, Li metal, Li alloy, and combinations thereof.

In other features, the cathode active material is selected from a group consisting of a layered oxide, an olivine-type oxide, a monoclinic-type oxide, a spinel-type oxide, a tavorite, or a combination thereof, where Me is a transition metal. The solid electrolyte in the solid electrolyte composite is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and/or borate-based solid electrolyte.

In other features, the oxide core in the solid electrolyte composite is selected from a group consisting of Al₂O₃, boehmite, MgO, SiO₂, TiO₂, ZrO₂, SnO₂, ZnO, Ce₂O₃, Fe₂O₃, Fe₃O₄, FeTiO₅, Cr₂O₃, CoO, Co₃O₄, VO₂, V₂O₃, NiO, and combinations thereof. The gel polymer electrolyte comprises a polymer in a range from 0.1 to 50 wt % and a liquid electrolyte in a range from 5 wt % to 90 wt %. The liquid electrolyte comprises a lithium salt, a solvent, and an electrolyte additive.

In other features, the lithium salt includes at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB). The solvent is selected from a group consisting of carbonate solvent, a lactone, a nitrile, a sulfone, an ether, and/or a phosphate, and ionic liquids.

A solid-state battery cell includes an anode electrode comprising an anode current collector, anode active material, a solid electrolyte, and a gel polymer electrolyte. A cathode electrode comprising a cathode current collector, a cathode active material, a solid electrolyte, and the gel polymer electrolyte. A separator layer comprises the gel polymer electrolyte and a solid electrolyte composite including a solid electrolyte coating arranged on an outer surface of an oxide core. The solid electrolyte in the solid electrolyte composite is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and/or borate-based solid electrolyte. The oxide core in the solid electrolyte composite is selected from a group consisting of Al₂O₃, boehmite, MgO, SiO₂, TiO₂, ZrO₂, SnO₂, ZnO, Ce₂O₃, Fe₂O₃, Fe₃O₄, FeTiO₅, Cr₂O₃, CoO, Co₃O₄, VO₂, V₂O₃, NiO, and combinations thereof.

In other features, the solid electrolyte in the anode electrode includes the solid electrolyte composite. The solid electrolyte in the cathode electrode includes the solid electrolyte composite. The solid electrolyte in the anode electrode and the cathode electrode includes the solid electrolyte composite. The anode active material is selected from a group consisting of carbonaceous material, silicon, silicon mixed with graphite, Li₄Ti₅O₁₂, a transition-metal, a metal oxide/sulfide, Li metal, Li alloy, and combinations thereof. The cathode active material is selected from a group consisting of a layered oxide, an olivine-type oxide, a monoclinic-type oxide, a spinel-type oxide, a tavorite, or a combination thereof, where Me is a transition metal.

In other features, the gel polymer electrolyte comprises a polymer in a range from 0.1 to 50 wt % and a liquid electrolyte in a range from 5 wt % to 90 wt %. The liquid electrolyte comprises a lithium salt, a solvent, and an electrolyte additive. The lithium salt includes at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB). The solvent is selected from a group consisting of carbonate solvent, a lactone, a nitrile, a sulfone, an ether, and/or a phosphate, and ionic liquids.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a battery cell;

FIG. 2 is a side cross-sectional view of an example of a battery cell including solid electrolyte composite in a separator layer according to the present disclosure;

FIG. 3A is a graph illustrating an example of capacity retention as a function of discharge rate for the battery cell according to the present disclosure;

FIG. 3B is a graph illustrating an example of voltage as a function of capacity retention percentage for the battery cell according to the present disclosure;

FIG. 3C is a graph illustrating an example of mass, cost and energy density for a battery cell including solid electrolyte and the battery cell including solid electrolyte composite according to the present disclosure;

FIG. 4 is a side cross-sectional view of an example of a battery cell including solid electrolyte composite in a separator layer according to the present disclosure;

FIG. 5 is a side cross-sectional view of an example of a battery cell including solid electrolyte composite in a separator layer and the anode electrode according to the present disclosure;

FIG. 6 is a side cross-sectional view of a battery cell including solid electrolyte composite in a separator layer and the cathode electrode according to the present disclosure; and

FIG. 7 is a side cross-sectional view of a battery cell including solid electrolyte composite in a separator layer, the anode electrode, and the cathode electrode according to the present disclosure.

In the drawings, reference numbers may be reused to identify similar and/or identical elements.

### DETAILED DESCRIPTION

While the present disclosure describes solid-state batteries (SSBs) used in vehicle applications, the battery cells can be used in stationary or other types of applications.

A low-density and low-cost solid electrolyte composite includes an oxide core having an outer surface that is coated with a solid electrolyte. In some examples, the solid electrolyte coating includes lithium-ion-conducting solid electrolyte particles (e.g., Li₇La₃Zr₂O₁₂ (LLZO)). In some examples, the oxide core that is coated includes low-density oxide particles (e.g., boehmite (AlO(OH)).

The solid electrolyte coating maintains the function of lithium-ion transportation while the oxide core acts as a structural support. The solid electrolyte composite reduces the mass of electrolyte material and enhances the gravimetric cell energy density. The solid electrolyte composite provides an effective solution for reducing solid electrolyte cost of battery cells. The solid electrolyte composite described further below does not significantly sacrifice battery rate capability as compared to pure solid electrolyte.

Referring now to FIG. 1, an oxide-based, solid-state battery cell 10 includes cathode electrodes 20, anode electrodes 40, and separator layers 32 arranged in a predetermined sequence in an enclosure 50. The cathode electrodes 20-1, 20-2, . . . , and 20-C (where C is an integer greater than one) include cathode active layers 24 arranged on one or both sides of cathode current collectors 26. The anode electrodes 40-1, 40-2, . . . , and 40-A (where A is an integer greater than one) include anode active layers 42 arranged on one or both sides of the anode current collectors 46. The active layers can comprise coatings including active material, solid electrolyte, a conductive adhesive, and/or a binder.

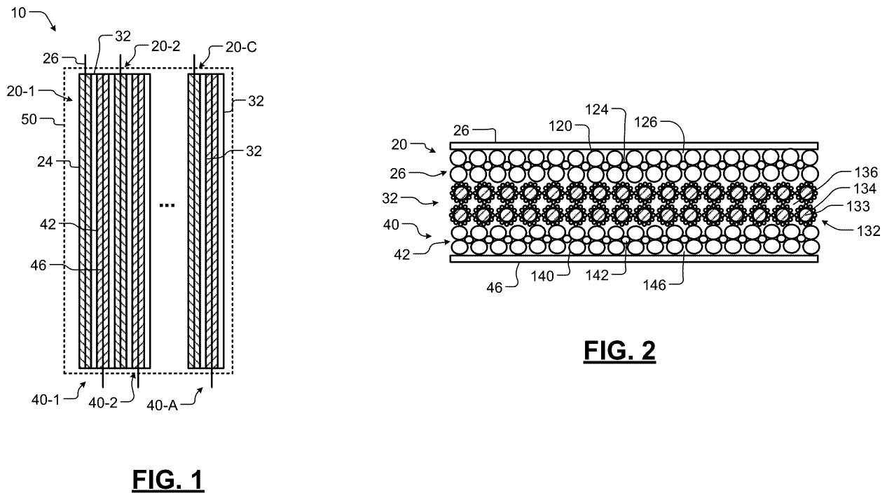

Referring now to FIG. 2, the cathode electrodes 20 include the cathode current collector 26, the cathode active material 120, a solid electrolyte 124, and a gel polymer electrolyte 126 arranged on one or both sides of the cathode current collector 26. The separator layer 32 includes a solid electrolyte composite 132 and the gel polymer electrolyte 136.

The solid electrolyte composite 132 includes an oxide core 133 and a solid electrolyte coating 134 arranged on an outer surface of the oxide core 133. In some examples, the solid electrolyte coating 134 comprises solid electrolyte such as Li₇La₃Zr₂O₁₂ (LZZO). In some examples, the oxide core 133 comprises oxide such as boehmite.

In some examples, the oxide core 133 comprises oxide having a density in a range from 0.2 g/cm³ to 1.5 g/cm³ (e.g., 0.6 g/cm³), a particle size in a range from 0.5 μm to 10 μm (e.g., d=4 μm), and a ratio of the solid electrolyte composite in a range from 50 vol % to 95 vol % (e.g., 82 vol %).

In some examples, the solid electrolyte coating 134 includes solid electrolyte having a size in a range from 2 nm to 1 μm (e.g., d=30 nm), a density in a range from 2 to 6 g/cm³, a Lit ionic conductivity greater than 1×10⁻⁶ S/cm at 25° C. (e.g., 2×10⁻³ S/cm), and a ratio in a range from 5 vol % to 50 vol % (e.g., 18 vol %).

The anode electrode 40 includes the anode current collector 46, anode active material 140, a solid electrolyte 142, and a gel polymer electrolyte 146 arranged on one or both sides of the anode current collector 46.

In some examples, the anode active material 140 comprises graphite. In some examples, the cathode active material 120 comprises a blend of LiMn_{0.7}Fe_{0.3}PO₄ (LMFP) and LiMn₂O₄ (LMO), although other active materials can be used. In some examples, the gel polymer electrolyte 146 comprises polyvinylidene fluoride—hexafluoropropylene (PVDF-HFP) with a lithium-ion conductor (e.g., 0.8 M LiTFSi and 0.8M LiBF₄ in EC/GBL (4:6 w/w), 1 wt % LiBOB, and 2.5 wt % VEC).

The small-sized solid electrolyte particles used in the solid electrolyte coating 134 provide Li-ion conduction paths and maintain the solid electrolyte function of Li-Ion transportation. The large-sized, low-density oxide used in the oxide core 133 reduces the mass of solid electrolyte material, enhances the gravimetric cell energy density, and reduces the cost of the solid electrolyte (−35%). For example, the solid electrolyte in the solid electrolyte coating 134 may have a density of 5 g/cm³ and a cost of $2500/kg. The oxide in the oxide core 133 may have a density of 0.6 g/cm³ and a cost of $6/kg. The solid electrolyte composite has a density of 1.4 g/cm³ and a cost of $1618/kg.

In some examples, the solid electrolyte composite is prepared by ball-milling large-sized solid electrolyte with the addition of ethanol as solvent and dispersant to form a nanoscale slurry. The slurry is mixed with the oxide cores to coat the oxide cores. Then, the ethanol solvent is removed.

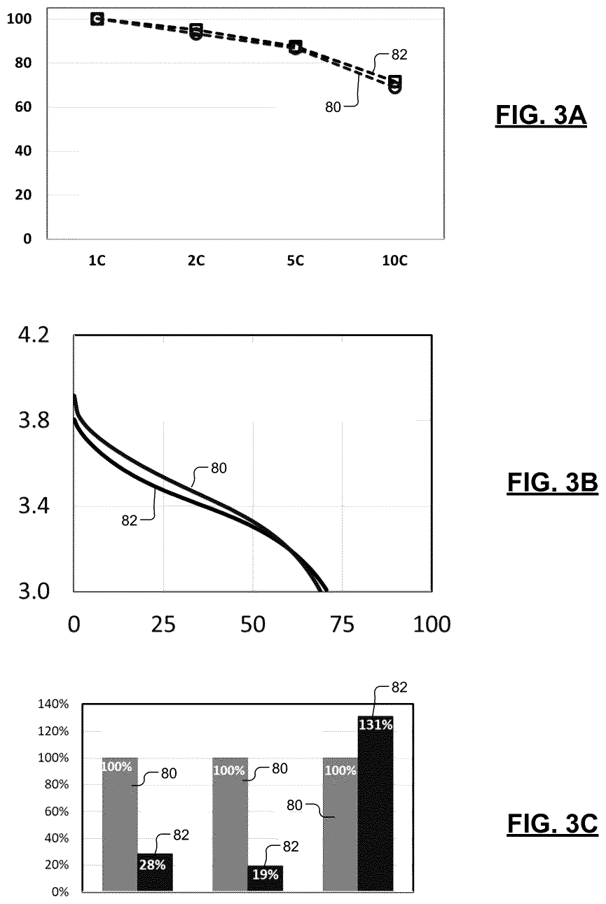

Referring now to FIGS. 3A to 3C, performance of solid-state battery cells using the solid electrolyte composite is shown. In this example, the cathode active layer has an areal loading of 1.05 mAh/cm² and a thickness of 44 μm. The anode has an areal loading of 1.1 mAh/cm² and a thickness of 23 μm. The separator layer has a thickness of 20 μm.

In FIG. 3A, the capacity retention of the battery cells using the solid electrolyte composite is similar to LLZO. In FIG. 3B, the voltage output is also similar to LLZO. In FIG. 3C, the mass is significantly lower, the cost is significantly lower, and the energy density is significantly higher than LLZO. As can be appreciated, the solid electrolyte composite in this example (e.g., LLZO coated boehmite) delivers similar cell performance as compared to LLZO without significantly sacrificing rate capability and at a lower cost.

Referring now to FIG. 4, the separator layer includes a mixture of solid electrolyte 240 and oxide 244. The solid electrolyte has a size in a range from 2 nm to 10 μm (e.g., d=2 μm), a density in a range from 2 g/cm³ to 6 g/cm³, a Li⁺ ionic conductivity greater than 1×10⁶ S/cm at 25° C. (e.g., 2×10⁻³ S/cm), and a ratio of 5 vol % to 60 vol % (e.g., 18 vol %).

The oxide 244 comprises low density oxide having a size in a range from 2 nm to 10 μm (e.g., d=4 μm), a density in a range from 0.2 g/cm³ to 1.5 g/cm³, (e.g., 0.6 g/cm³), and a ratio in a range from 50 vol % to 95 vol % (e.g., 82 vol %).

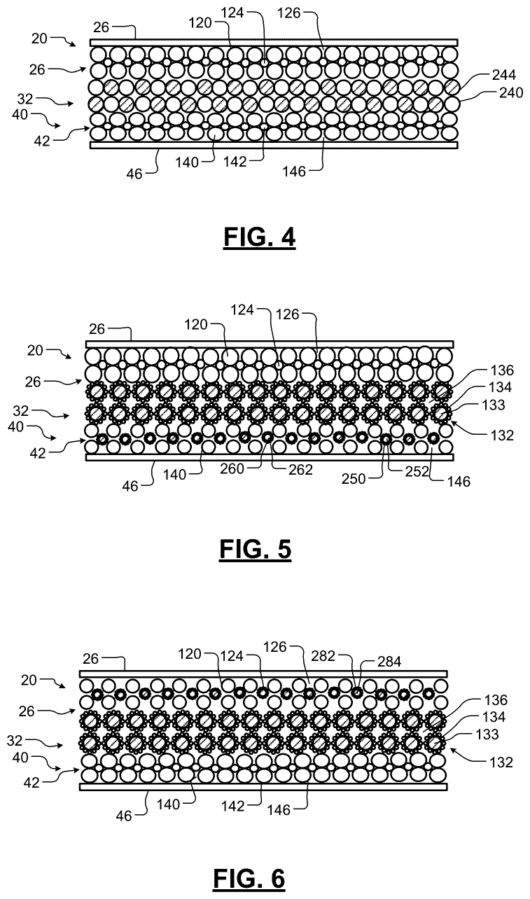

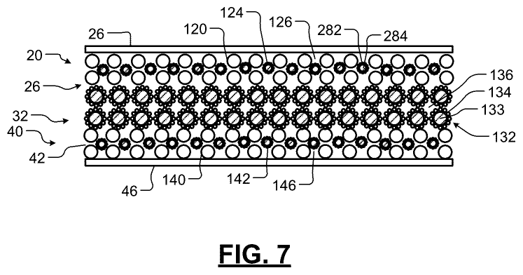

Referring now to FIGS. 5 to 7, the solid electrolyte composite can be used in the anode electrode 40, the cathode electrode 20, or both. In FIG. 5, the solid electrolyte 142 in the anode electrode 40 comprises an oxide core 250 and a coating 252 of solid electrolyte. In FIG. 6, the solid electrolyte composite is used as the solid electrolyte in the cathode electrode 20. The solid electrolyte 124 comprises an oxide core 282 and a coating 284 of solid electrolyte. Referring now to FIG. 7, the solid electrolyte composite is used as the solid electrolyte in the anode electrode 40 and the cathode electrode 20.

In some examples, the solid electrolyte in the solid electrolyte composite is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and/or borate-based solid electrolyte.

Examples of oxide-based solid electrolyte include garnet type (e.g., Li₇La₃Zr₂O₁₂), Perovskite type (e.g., Li₃ₓLa_{2/3-x}TiO₃), NASICON type (e.g., Li_{1.4}Al_{0.4}Ti_{1.6}(PO₄)₃ and Li₁₊ₓ AlₓGe₂₋ₓ(PO₄)₃), and LISICON type (e.g., Li₂₊₂ₓZn₁₋ₓ GeO₄). Examples of metal-doped or aliovalent-substituted oxide solid electrolyte. include Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, and/or Al-substituted perovskite, Li_{1+x+y}AlₓT₂₋ₓSi_{y}P_{3-y}O₁₂.

Examples, of sulfide-based solid electrolyte include Li₂S—P₂S₅ system, Li₂S—P₂S₅—MOₓ system, Li₂S—P₂S₅—MSₓ system, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X=Cl, Br, or I), Li_{9.54}Si_{1.74}P_{1.44}S_{11.7}Cl_{0.3}(25 mS/cm), Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5S}n_{0.5})P₂S₁₂, Li_{3.833}Sn_{0.833}As_{0.166}S₄, Lil-Li₄SnS₄, and/or Li₄SnS₄.

Examples of nitride-based solid electrolyte include Li₃N, Li₇PN₄, and LiSi₂N₃. Examples of hydride-based solid electrolyte include LiBH₄, LiBH₄—LiX (X═Cl, Br or I), LiNH₂, Li₂NH, LiBH₄—LiNH₂, and Li₃AlH₆. Examples of halide-based solid electrolyte include Lil, Li₃InCl₆, Li₂CdCl₄, Li₂MgCl₄, Li₂Cdl₄, Li₂ZnI₄, and/or Li₃OCl. Examples of borate-based solid electrolyte include Li₂B₄O₇ and/or Li₂O—B₂O₃—P₂O₅.

Examples of low density oxide include one or more materials selected from a group consisting of Al₂O₃, boehmite, MgO, SiO₂, TiO₂, ZrO₂, SnO₂, ZnO, Ce₂O₃, Fe₂O₃, Fe₃O₄, FeTiO₅, Cr₂O₃, CoO, Co₃O₄, VO₂, V₂O₃, and/or NiO (where Mg is magnesium, Fe is iron, Ti is titanium, Zr is zirconium, Cr is chromium, Co is cobalt, V is vanadium, and Ni is nickel).

In some examples, the cathode electrodes comprise cathode active material (in a range from 30 wt % to 98 wt %), solid electrolyte (in a range from 1 to 50 wt %), a conductive additive (in a range from 0 to 30 wt %), and/or a binder (in a range from 0 to 20 wt %).

In some examples, the cathode active material comprises one or more materials selected from a group consisting of a layered oxide represented by the formula LiMeO₂, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof).

In some examples, the anode electrodes comprise anode active material (in a range from 30 to 98 wt %), solid electrolyte (in a range from 1 to 50 wt %), a conductive additive (in a range from 0 to 30 wt %), and/or a binder (in a range from 0 to 20 wt %). In some examples, the anode active material is selected from a group consisting of carbonaceous material (e.g., graphite, hard carbon, soft carbon etc.), silicon, silicon mixed with graphite, Li₄Ti₅O₁₂, transition-metal (e.g., tin (Sn)), metal oxide/sulfide (e.g., TiO₂, FeS and the like), and other lithium-accepting anode materials, Li metal and Li alloy.

In some examples, the conductive additive is selected from a group consisting of carbon black, graphite, graphene, graphene oxide, Super P, acetylene black, carbon nanofibers, carbon nanotubes, and/or other electronically conductive additives.

In some examples, the binder is selected from a group consisting of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and/or styrene ethylene butylene styrene copolymer (SEBS).

In some examples, the gel polymer electrolyte comprises 0 to 30 wt % of the separating layer and/or the electrode layer(s). In some examples, the gel polymer electrolyte comprises a polymer (in a range from 0.1 to 50 wt %) and a liquid electrolyte (in a range from 5 to 90 wt %). In some examples, the liquid electrolyte comprises a lithium salt, a solvent, and an electrolyte additive. In some examples, the lithium salt includes at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB).

In some examples, the solvent dissolves the lithium salts and enables lithium ion conductivity. In some examples, the solvent is selected from a group consisting of carbonate solvent, a lactone, a nitrile, a sulfone, an ether, and/or a phosphate.

Examples of carbonate solvent include ethylene carbonate (EC), propylene carbonate (PC), glycerol carbonate, vinylene carbonate, fluoroethylene carbonate, and/or 1,2-butylene carbonate. Examples of lactones include γ-butyrolactone and δ-valerolactone. Examples of nitriles include succinonitrile, glutaronitrile, and/or adiponitrile. Examples of sulfones include tetramethylene sulfone, ethyl methyl sulfone, vinyl sulfone, phenyl sulfone, 4-fluorophenyl sulfone, and/or benzyl sulfone. Examples of ethers include triethylene glycol dimethylether (triglyme, G3), tetraethylene glycol dimethylether (tetraglyme, G4), 1,3-dimethoxy propane, and/or 1,4-dioxane. Examples of phosphates include triethyl phosphate and/or trimethyl phosphate.

In some examples, ionic liquids such as ionic liquid cations and ionic liquid anions are used. In some examples, the ionic liquid cations are selected from a group consisting of [Emim]+: 1-ethyl-3-methylimidazolium, [PP₁₃]⁺: 1-Propyl-1-methylpiperidinium, [PP₁₄]⁺: 1-Butyl-1-methylpiperidinium, [Pyr₁₂]⁺: 1-Methyl-1-ethylpyrrolidinium, [Pyr₁₃]⁺: 1-Propyl-1-methylpyrrolidinium, and/or [Pyr₁₄]⁺: 1-Butyl-1-methylpyrrolidinium. In some examples, the ionic liquid anions are selected from a group consisting of TFSI and/or FSI.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A solid-state battery cell comprising:
an anode electrode comprising an anode current collector, anode active material, a solid electrolyte, and a gel polymer electrolyte;
a cathode electrode comprising a cathode current collector, a cathode active material, a solid electrolyte, and the gel polymer electrolyte; and
a separator layer comprising the gel polymer electrolyte and a solid electrolyte composite including a solid electrolyte coating arranged on an outer surface of an oxide core.

2. The solid-state battery cell of claim 1, wherein the solid electrolyte in the anode electrode includes the solid electrolyte composite.

3. The solid-state battery cell of claim 1, wherein the solid electrolyte in the cathode electrode includes the solid electrolyte composite.

4. The solid-state battery cell of claim 1, wherein the solid electrolyte in the anode electrode and the cathode electrode includes the solid electrolyte composite.

5. The solid-state battery cell of claim 1, wherein the anode active material is selected from a group consisting of carbonaceous material, silicon, silicon mixed with graphite, Li₄Ti₅O₁₂, a transition-metal, a metal oxide/sulfide, Li metal, Li alloy, and combinations thereof.

6. The solid-state battery cell of claim 1, wherein the cathode active material is selected from a group consisting of a layered oxide, an olivine-type oxide, a monoclinic-type oxide, a spinel-type oxide, a tavorite, or a combination thereof, where Me is a transition metal.

7. The solid-state battery cell of claim 1, wherein the solid electrolyte in the solid electrolyte composite is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and/or borate-based solid electrolyte.

8. The solid-state battery cell of claim 1, wherein the oxide core in the solid electrolyte composite is selected from a group consisting of Al₂O₃, boehmite, MgO, SiO₂, TiO₂, ZrO₂, SnO₂, ZnO, Ce₂O₃, Fe₃O₃, Fe₃O₄, FeTiO₅, Cr₂O₃, CoO, Co₃O₄, VO₂, V₂O₃, NiO, and combinations thereof.

9. The solid-state battery cell of claim 1, wherein the gel polymer electrolyte comprises a polymer in a range from 0.1 to 50 wt % and a liquid electrolyte in a range from 5 wt % to 90 wt %.

10. The solid-state battery cell of claim 9, wherein the liquid electrolyte comprises a lithium salt, a solvent, and an electrolyte additive.

11. The solid-state battery cell of claim 10, wherein the lithium salt includes at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB).

12. The solid-state battery cell of claim 10, wherein the solvent is selected from a group consisting of carbonate solvent, a lactone, a nitrile, a sulfone, an ether, and/or a phosphate, and ionic liquids.

13. A solid-state battery cell comprising:
an anode electrode comprising an anode current collector, anode active material, a solid electrolyte, and a gel polymer electrolyte;
a cathode electrode comprising a cathode current collector, a cathode active material, a solid electrolyte, and the gel polymer electrolyte; and
a separator layer comprising the gel polymer electrolyte and a solid electrolyte composite including a solid electrolyte coating arranged on an outer surface of an oxide core,
wherein the solid electrolyte in the solid electrolyte composite is selected from a group consisting of oxide-based solid electrolyte, metal-doped or aliovalent-substituted oxide solid electrolyte, sulfide-based solid electrolyte, nitride-based solid electrolyte, hydride-based solid electrolyte, halide-based solid electrolyte, and/or borate-based solid electrolyte, and
the oxide core in the solid electrolyte composite is selected from a group consisting of Al₂O₃, boehmite, MgO, SiO₂, TiO₂, ZrO₂, SnO₂, ZnO, Ce₂O₃, Fe₂O₃, Fe₃O₄, FeTiO₅, Cr₂O₃, CoO, Co₃O₄, VO₂, V₂O₃, NiO, and combinations thereof.

14. The solid-state battery cell of claim 13, wherein the solid electrolyte in the anode electrode includes the solid electrolyte composite.

15. The solid-state battery cell of claim 13, wherein the solid electrolyte in the cathode electrode includes the solid electrolyte composite.

16. The solid-state battery cell of claim 13, wherein the solid electrolyte in the anode electrode and the cathode electrode includes the solid electrolyte composite.

17. The solid-state battery cell of claim 13, wherein:
the anode active material is selected from a group consisting of carbonaceous material, silicon, silicon mixed with graphite, Li₄Ti₅O₁₂, a transition-metal, a metal oxide/sulfide, Li metal, Li alloy, and combinations thereof; and
the cathode active material is selected from a group consisting of a layered oxide, an olivine-type oxide, a monoclinic-type oxide, a spinel-type oxide, a tavorite, or a combination thereof, where Me is a transition metal.

18. The solid-state battery cell of claim 13, wherein:
the gel polymer electrolyte comprises a polymer in a range from 0.1 to 50 wt % and a liquid electrolyte in a range from 5 wt % to 90 wt %; and
the liquid electrolyte comprises a lithium salt, a solvent, and an electrolyte additive.

19. The solid-state battery cell of claim 18, wherein the lithium salt includes at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB).

20. The solid-state battery cell of claim 19, wherein the solvent is selected from a group consisting of carbonate solvent, a lactone, a nitrile, a sulfone, an ether, and/or a phosphate, and ionic liquids.
